(19) United States
(12) Patent Application Publication
(10) Pub. No.: US 2007/0085426 A1
(43) Pub. Date: Apr. 19, 2007

(54) Stator structure and manufacturing method thereof

(75) Inventors: Chien-Ming Lee, Taoyuan Hsien (TW); Ying-Chi Chen, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/376,098

(22) Filed: Mar. 16, 2006

(30) Foreign Application Priority Data
Oct. 13, 2005 (TW) 094135706

(51) Int. Cl. H02K 1/04; H02K 5/12; H02K 5/10

(52) U.S. Cl. 310/43; 310/86; 310/88; 417/354; 417/423.13

(57) ABSTRACT

A stator structure includes a stator assembly and a protective body, and the stator assembly is covered by the protective body. Additionally, a manufacturing method of the stator structure, which includes the steps of providing a stator assembly, providing a mold, disposing the stator assembly in the mold, applying a filler into a space defined between the mold and the stator assembly, and removing the mold to form the stator structure with the protective body, is also disclosed.

### BACKGROUND OF THE INVENTION

1. Field of Invention

The invention relates to a stator structure and manufacturing method thereof and, in particular, to a waterproof stator structure and manufacturing method thereof.

2. Related Art

Accompanying with the rapid development of the electronic industry, the motor has been widely applied to various fields and has become one of the well-developed technologies in the industry. Vehicles, fans, water pumps, and even computer peripheral devices, such as printers or scanners, are all using motors to facilitate their normal operations.

However, the stator, coil and circuit board of the motor are very sensitive to moisture which will cause the motor to be moistened and thus shorten the lifetime of the motor. Additionally, the moisture could result in a short circuit in the motor to cause malfunction of a device.

Take fan as an example, in order to prevent the moisture from entering the inside of the motor, the conventional solution is to shorten the gap between the rotor and the stator and the gap between the fan frame and the stator. However, this kind of protection is still insufficient to prevent the moisture from penetrating inside the motor. Therefore, it is an important subject to provide a motor with a waterproof effect.

### SUMMARY OF THE INVENTION

In view of the foregoing, the invention is to provide a waterproof stator structure, which is adapted to the high-moisture and high-salt environment, and a manufacturing method thereof.

To achieve the above, a stator structure of the invention includes a stator assembly and a protective body. The stator assembly has a plurality of silicon steel sheets, a coil and a- circuit board. The silicon steel sheets are stacked, and the coil winds on the silicon steel sheets. The circuit board is located at one side of the silicon steel sheets and electrically connected to the silicon steel sheets. The stator assembly is entirely covered by the protective body, so that the stator structure has the waterproof effect to adapt to the high-moisture or high-salt environment.

To achieve the above, a manufacturing method of a stator structure includes the steps of providing a stator assembly and a mold; disposing the stator assembly in the mold; applying a filler into a space defined between the mold and the stator assembly; and removing the mold to form a stator structure with a protective body. Additionally, the manufacturing method further includes the steps of adding a film between the mold and the stator assembly, and applying the filler into a space defined between the film and the stator assembly. In this case, the material of the film preferably does not stick with that of the filler.

As mentioned above, the manufacturing method of the stator structure of the invention is to dispose the stator assembly in the mold and apply the filler into the space defined between the mold and the stator assembly; and after solidifying the filler and removing the mold, the stator structure will have the protective body covering the stator assembly. According to this manufacturing method, the mold is directly designed for the stator structure without considering the configuration and size of other components, such as a fan frame; thus, the size of the mold can be reduced. In addition, the manufacturing method of the invention further includes the step of adding the film, which can be easily separated from the filler, between the mold and the stator structure so as to avoid damaging the protective body when the mold is removed.

Moreover, the invention discloses another manufacturing method of a stator structure, which includes the steps of disposing a stator assembly on a base of a fan; providing a mold and a film to cover the stator assembly, wherein the film is located between the mold and the stator assembly; applying a filler into a space defined between the film and the stator assembly; and removing the mold to form the stator assembly with a protective body. This manufacturing method utilizes the film, which is placed between the mold and the stator structure and easily separated from the filler, to avoid damaging the protective body when the mold is removed.

In this case, the filler can be made of a liquid or fluid material such as epoxy, silica gel or polyurethane. The filler becomes the protective body with the waterproof effect after being solidified, so that the stator structure can be normally operated in the high-moisture or high-salt environment. Specifically, the film can be made of the polyvinyl chloride, so that it can be easily separated from the filler after the stator structure having the protective body is manufactured.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing a stator structure according to an embodiment of the invention;

FIG. 2 is a schematic diagram showing the stator structure of FIG. 1 assembled with a fan frame;

FIG. 3 is a flow chart showing a manufacturing method of a stator structure according to a first embodiment of the invention;

FIG. 4A to FIG. 4C are schematic diagrams showing the manufacturing procedures according to the first embodiment of the invention;

FIG. 5 is a flow chart showing the manufacturing method of a stator structure according to a second embodiment of the invention; and

FIG. 6A to FIG. 6C are schematic diagrams showing the manufacturing procedures according to the second embodiment of the invention.

### DETAILED DESCRIPTION OF THE INVENTION

The present invention will be apparent from the following detailed description, which proceeds with reference to the accompanying drawings, wherein the same references relate to the same elements.

Referring to FIG. 1, a stator structure 1 according to an embodiment of the invention includes a stator assembly 11 and a protective body 12 covering the stator assembly 11.

In this embodiment, the stator assembly 11 includes a plurality of stacked silicon steel sheets 112, a coil 113 winding on the silicon steel sheets 112, and a circuit board 111 which is located on one side of the silicon steel sheets 112 and electrically connected to the silicon steel sheets 112. Additionally, a wire 1111 is electrically connected to the circuit board 111. The protective body 12 covers the circuit board 111, the silicon steel sheets 112, and the coil 113 so that the circuit board 111, the silicon steel sheets 112 and the coil 113 are isolated from the exterior environment. In this case, the protective body 12 has the waterproof effect and is made of epoxy, silica gel, or polyurethane (PU).

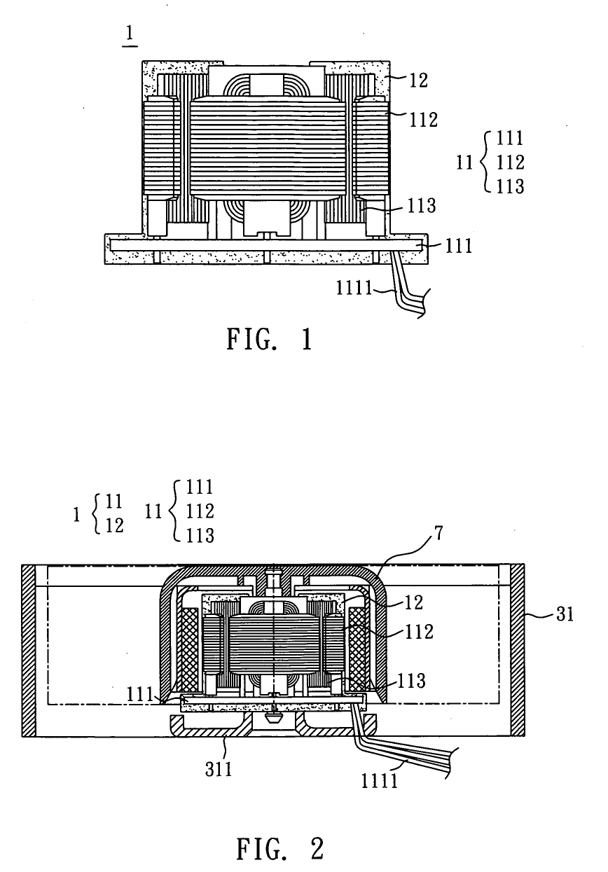

Referring to FIG. 2, the stator structure 1 according to the embodiment of the invention can be applied to a fan, which includes a fan frame 31 having a base 311. The stator assembly 11 is disposed on the base 311 of the fan frame 31. By assembling a rotor 7 and the stator assembly 11 with the fan frame 31, the fan is entirely manufactured.

As mentioned above, the stator structure has the stator assembly enclosed in the protective body so that the stator structure has the waterproof effect. Therefore, a fan having such stator structure can be normally operated in the high-moisture or high-salt environment.

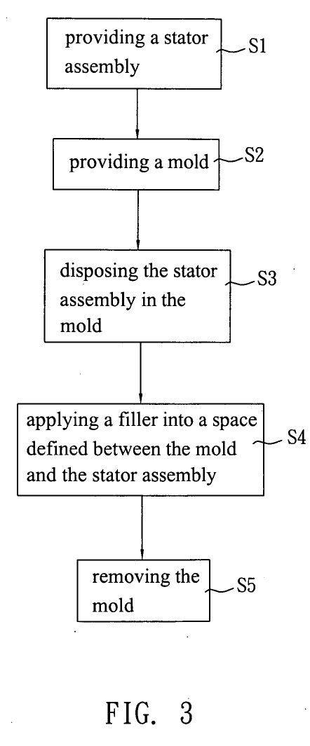

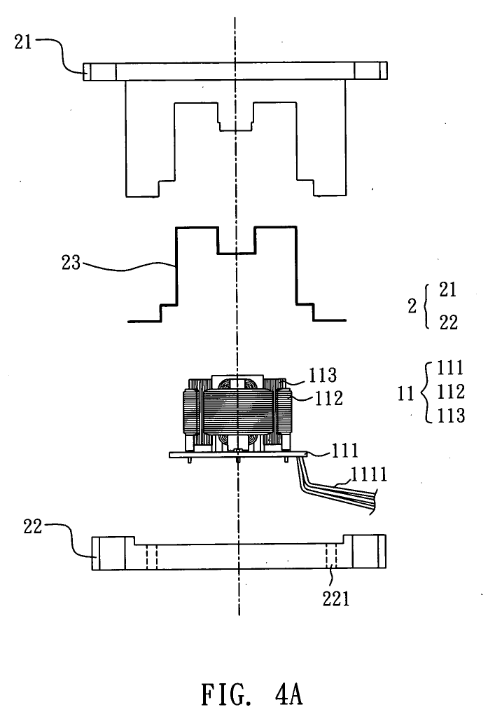

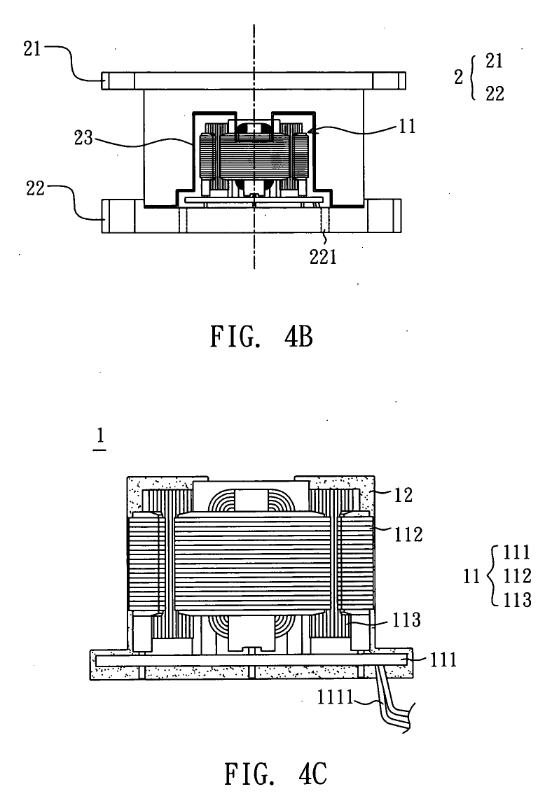

Referring to FIG. 3 to FIG. 4C, the manufacturing method of the stator structure according to the first embodiment of the invention is described as below. FIG. 3 is a flow chart showing the manufacturing method of the stator structure according to the first embodiment of the invention.

The manufacturing method of the stator structure includes the following steps. Referring to FIG. 4A, the steps S1 and S2 are to provide a stator assembly 11 and a mold 2, respectively. As described above, the stator assembly 11 includes a circuit board 111, stacked silicon steel sheets 112 and a coil 113. The mold 2 includes a top cover 21 and a bottom cover 22. A hole 221 is formed in the bottom cover 22 in this embodiment, but it also can be formed in the top cover 21. In the embodiment, a film 23 is further disposed between the stator assembly 11 and the mold 2. The film 23 is in contact with the top cover 21 and covers most part of the stator assembly 11. Preferably, the film 23 is made of polyvinyl chloride.

Referring to FIG. 4B, the step S3 is to dispose the stator assembly 11 in the mold 2, and the top cover 21 and the bottom cover 22 are assembled together tightly. In the embodiment, a cave is formed at one side of the mold 2 for the wire 1111 passing through.

The step S4 is to apply a filler into a space defined between the stator assembly 11 and the mold 2. In the embodiment, the filler is a liquid or fluid material, which is applied into the mold through the hole 221 of the bottom cover 22. In more detail, the filler are applied into a space defined between the film 23, the stator assembly 11 and the bottom cover 22. Then, the filler is solidified by fast cooling at low temperature or curing at high temperature to form a protective body 12 after filler is applied.

Referring to FIG. 4C, the step S5 is to remove the mold 2 to form the stator structure 1 with the protective body 12. In the embodiment, the protective body 12 has the waterproof effect which is made of epoxy, silica gel or polyurethane. The manufacturing method further includes the step of removing the film 23 after removing the mold 2. The film 23 is made of the material that can easily be separated from the protective body 12 so as to avoid damaging the protective body 12.

As mentioned above, a device having the stator structure with the waterproof effect can be used and operated in the high-moisture and high-salt environment. By the manufacturing method of the present invention, the stator assemblies of the same size can be processed with the same mold so as to decrease the manufacturing cost. Moreover, the film can avoid damaging the protective body when removing the mold, so as to increase the manufacturing yield. In addition, the mold is only designed for the stator structure without considering other components so as to reduce its size, and after the stator structure with waterproof effect is manufactured, it can be easily assembled with other components such as the fan frame to form an integral device.

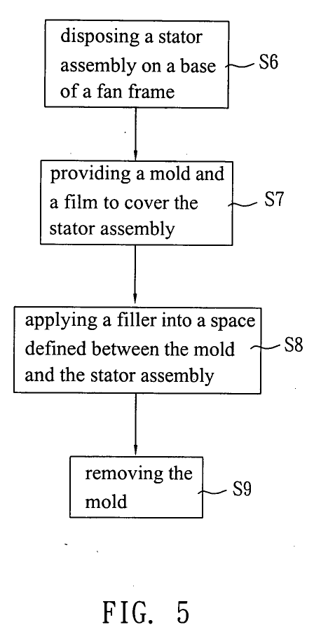

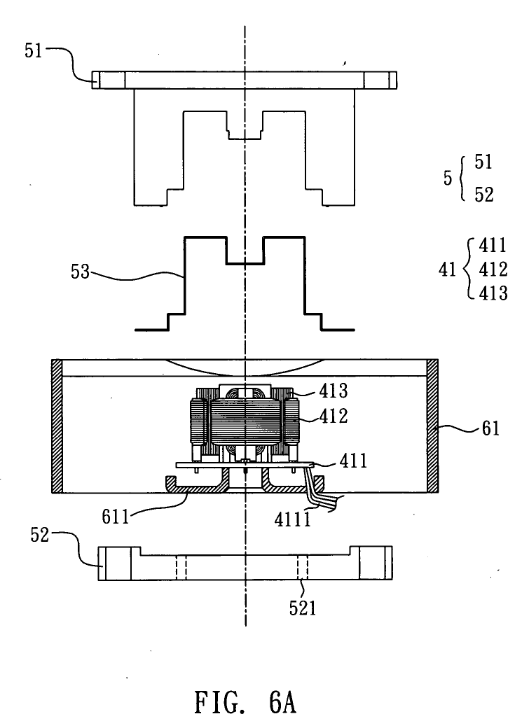

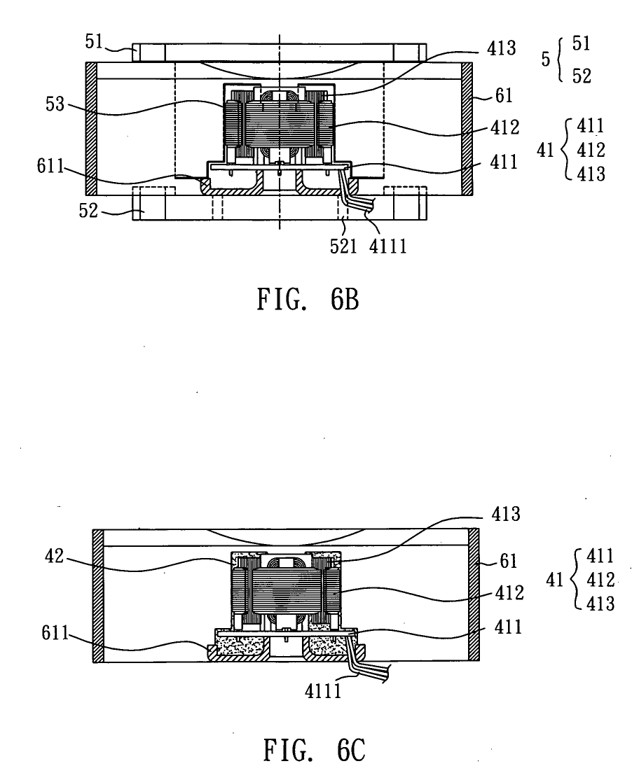

Referring to FIG. 5 to FIG. 6C, the manufacturing method of the stator structure according to the second embodiment of the invention is described as below. FIG. 5 is a flow chart showing the manufacturing method of the stator structure according to the second embodiment of the invention.

The manufacturing method of the stator structure according to the second embodiment of the invention includes the following steps. Referring to FIG. 6A, the step S6 is to dispose a stator assembly 41 on a base 611 of a fan frame 61.

The step S7 is to provide a mold 5 and a film 53 for covering the stator assembly 41, and the film 53 is disposed between the mold 5 and the stator assembly 41. The stator assembly 41 includes a circuit board 411, a plurality of silicon steel sheets 412, a coil 413, and a wire 4111 electrically connected to the circuit board 411. The mold 5 includes a top cover 51 and a bottom cover 52. A hole 521 is formed in the bottom cover 52, in this embodiment, but it also can be formed in the top cover 51. The size of the top cover 51 and the bottom cover 52 is designed in accordance with the configuration and the size of the stator assembly 41 and the base 611 of the fan frame 61. In this embodiment, the film 53 is made of the polyvinyl chloride. Additionally, a cave is formed on one side of the mold 5 for the wire 4111 passing through.

Referring to FIG. 6B, the step S8 is to apply a filler into a space defined between the film 53 and the stator assembly 41. In the embodiment, the filler is a liquid or fluid material, which is applied into the mold 5 through the hole 521 of the bottom cover 52. In more detail, the filler is applied into a space defined among the film 53, the stator assembly 41 and the bottom cover 52. Then, the filler is solidified to form a protective body by fast cooling at low temperature or curing at high temperature after the filler is applied.

Finally, referring to FIG. 6C, the step S9 is to remove the mold 5 to form a stator structure 41 with the protective body 42. In the embodiment, the protective body 42 has the waterproof effect and is made of epoxy, silica gel or polyurethane. The manufacturing method further includes the step of removing the film 53 after removing the mold 5. The film 53 is made of the material that can be easily separated from the protective body 42 so as to avoid damaging the protective body 42.

As mentioned above, a device having the stator structure with the waterproof effect can be used and operated in the high-moisture and high-salt environment. By the manufacturing method of the present invention, the stator assemblies of the same size can be processed with the same mold so as to decrease the manufacturing cost. Since the stator assembly is fixed on the fan frame at first, and then the protective body is formed to cover the stator assembly, the assembly process for the stator structure and fan frame can be shortened. Furthermore, the film can avoid the damage of the protective body while removing the mold so as to increase the manufacturing yield.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A stator structure comprising:
a stator assembly, which includes:
a plurality of stacked silicon steel sheets,
a coil winding on the silicon steel sheets, and
a circuit board located on one side of the silicon steel sheets; and
a protective body covering the stator assembly to avoid external moisture into the stator assembly.

2. The stator structure according to claim 1, wherein the protective body contains a waterproof body made of epoxy, silica gel, or polyurethane.

3. The stator structure according to claim 1, wherein the stator structure is disposed in a fan frame.

4. A manufacturing method of a stator structure, comprising the steps of:
providing a stator assembly;
providing a mold;
disposing the stator assembly in the mold;
applying a filler into a space defined between the mold and the stator assembly; and
removing the mold to form the stator structure with a protective body.

5. The manufacturing method according to claim 4, wherein the mold has a hole for applying the filler.

6. The manufacturing method according to claim 5, further comprising the step of: disposing a film between the mold and the stator assembly.

7. The manufacturing method according to claim 6, wherein the mold comprises a first cover and a second cover, the film is in contact with the first cover, and the second cover has a hole for applying the filler.

8. The manufacturing method according to claim 6, wherein the filler is applied into the space defined between the film and the stator assembly.

9. The manufacturing method according to claim 6, wherein the film comprises polyvinyl chloride.

10. The manufacturing method according to claim 9, wherein the protective body contains a waterproof body made of epoxy, silica gel, or polyurethane.

11. The manufacturing method according to claim 6, further comprising the step of:
removing the film after the mold is removed.

12. The manufacturing method according to claim 5, wherein the filler is a liquid or fluid material, and after the filler is applied, the filler is solidified to form the protective body by fast cooling at low temperature or curing at high temperature.

13. A manufacturing method of a stator structure, comprising the steps of:
disposing a stator assembly on a base of a fan frame;
providing a mold and a film to cover the stator assembly, wherein the film is disposed between the mold and the stator assembly;
applying a filler into a space defined between the film and the stator assembly; and
removing the mold to form a protective body for covering the stator assembly.

14. The manufacturing method according to claim 13, wherein the mold has a hole for applying the filler.

15. The manufacturing method according to claim 14, wherein the mold comprises a first cover and a second cover and the film is in contact with the first cover, and the hole is formed in the second cover.

16. The manufacturing method according to claim 13, wherein the filler is applied into the space defined among the film, the stator assembly, and the base.

17. The manufacturing method according to claim 13, wherein the film comprises polyvinyl chloride.

18. The manufacturing method according to claim 17, wherein the protective body is a waterproof body made of epoxy, silica gel, or polyurethane.

19. The manufacturing method according to claim 13, further comprising the step of: removing the film after the mold is removed.

20. The manufacturing method according to claim 13, wherein the filler is a liquid or fluid material, and after the filler is applied, the filler is solidified to form the protective body by fast cooling at low temperature or curing at high temperature.
